(19) United States
(12) Patent Application Publication
(10) Pub. No.: US 2013/0138554 A1
(43) Pub. Date: May 30, 2013

(54) DYNAMIC RISK ASSESSMENT AND CREDIT STANDARDS GENERATION

(71) Applicants: Andrey N. Nikankin, Sankt-Petersburg (RU); Rodion Shishkov, St. Petersburg (RU)

(72) Inventors: Andrey N. Nikankin, Sankt-Petersburg (RU); Rodion Shishkov, St. Petersburg (RU)

(73) Assignee: RAWLLIN INTERNATIONAL INC.

(21) Appl. No.: 13/307,457

(22) Filed: Nov. 30, 2011

(51) Int. Cl. G06Q 40/02

(52) U.S. Cl. 705/38

(57) ABSTRACT

Disclosed are electronic systems and techniques for implementing dynamic risk assessment and credit standards generation. The risk assessment component can dynamically determine a risk of lending to a potential borrower based on a set of risk assessment criteria, and classify the potential borrower based on the risk. In addition, the risk assessment component can forecast a subset of the risk assessment criteria. A standards generation component can dynamically generate a set of lending criteria for respective classifications of potential borrowers based at least in part on a set of predetermined criterion or previous lending outcomes. An approval component can determine whether the potential borrower is eligible for one or more loans as a function of the set of lending criteria corresponding to the determined classification, and a terms component can generate a set of terms for the one or more loans.

### TECHNICAL FIELD

The subject application relates to finance and credit, and, more particularly, to dynamic risk assessment and credit standards generation.

### BACKGROUND

A number of consumers have experience with short term loans, payday advances, cash advances, and so forth. These types of financial instruments often require proof of employment and financial viability, such as a checking account and evidence of employment. Typically, the interest rate for such instruments can be high, due to the level of risk experienced by the lender. However, when a consumer needs to obtain a quick credit decision, there may be few alternatives except borrowing from pawn shops, friends, or family.

Typically, credit lending organizations regularly reevaluate their credit lending requirements. The process may be entirely or partly manual, and in most cases relies heavily on past events. However, the time between reevaluations, and the time required for the organization to manually analyze past events and update their lending requirements can be relatively lengthy. This can result in an inability for credit lending organizations to quickly react to changing trends, or incorporate future events or trends that have not already occurred at the time of the reevaluation.

The above-described deficiencies of today's credit applications and lending requirements are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for dynamic risk assessment and credit standards generation are contained herein. An exemplary system, includes a risk assessment component configured to determine a risk of lending to a potential borrower, and classify the potential borrower as a function of the risk, a standards generation component configured to determine a set of lending criteria for the determined classification, and an approval component configured to determine an eligibility of the potential borrower for one or more loans based on a comparison of a profile associated with the potential borrower and the set of lending criteria for.

In another non-limiting embodiment, an exemplary method is provided that includes determining a risk of lending to a user, and classifying the user as a function of the risk, generating a set of lending criteria for the determined classification, and determining an eligibility of the user for one or more loans based on a comparison of a profile associated with the user and the set of lending criteria.

In still another non-limiting embodiment, an exemplary computer readable storage medium is provided that includes determining a risk of lending to a potential borrower, and classifying the potential borrower based at least in part on the risk, generating a set of lending criteria for the classification of the potential borrower, and determining an eligibility of the potential borrower for at least one loan based on a comparison of a profile associated with the potential borrower and the set of lending criteria.

In yet another non-limiting embodiment, an exemplary system is provided that includes means for determining a risk of lending to a potential borrower, and classifying the potential borrower as a function of the risk, means for generating a set of lending criteria for the determined classification, and means for determining an eligibility of the potential borrower for at least one loan based on a comparison of a profile associated with the potential borrower and the set of lending criteria.

### BRIEF DESCRIPTION OF DRAWINGS

FIG. 1 illustrates an example system for dynamic risk assessment and credit standards generation in accordance with various aspects described herein;

FIG. 2 illustrates an example credit standards component in accordance with various aspects described herein;

FIG. 3 illustrates an example risk assessment component in accordance with various features described herein;

FIG. 4 illustrates an example standards generation component in accordance with various aspects described herein;

FIG. 5 illustrates a block diagram of an exemplary non-limiting system that provides additional features or aspects in connection with dynamic risk assessment and credit standards generation;

FIG. 6 illustrates an example methodology for dynamic risk assessment and credit standards generation in accordance with various aspects described herein;

FIG. 7 illustrates an example methodology for dynamic risk assessment in accordance with various aspects described herein;

FIG. 8 illustrates an example methodology for dynamic standards generation in accordance with various aspects described herein;

FIG. 9 is a block diagram representing exemplary non-limiting networked environments in which various non-limiting embodiments described herein can be implemented; and

FIG. 10 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

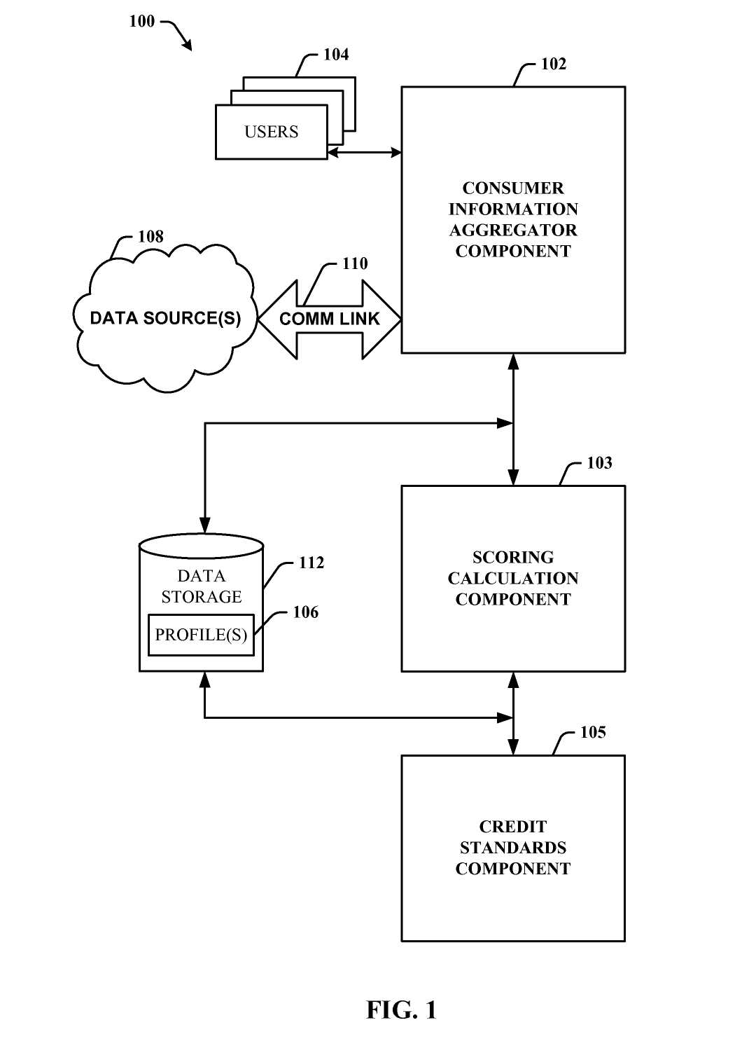

Referring initially to FIG. 1, illustrated is an example system 100 for dynamic risk assessment and credit standards generation in accordance with various aspects described herein. The system 100 includes a consumer information aggregator component 102 (aggregator component 102), a scoring calculation component 103, and a credit standards component 105. The consumer information aggregator component 102 can obtain, locate, or otherwise acquire data relating to a user 104, and generate a profile of candidate characteristics 106 (profile 106) based at least in part on the data. The aggregator component 102 obtains, acquires, or otherwise receives one or more identifiers associated with the user. For example, the identifiers can include but are not limited to the user's 104 name, date of birth, email address, home address, phone number, and so forth. The aggregator component 102 can acquire data relating to the user 104 by searching a set of data sources 108 using the identifiers, and collecting a set of search results. The data sources 108 can include virtually any open source or publicly available sources of information, including but not limited to websites, search engine results, social networking websites, online resume databases, job boards, government records, online groups, payment processing services, online subscriptions, and so forth. In addition, the data sources 108 can include private databases, such as credit reports, loan applications, and so forth. The aggregator component 102 can connect to the data sources 108 via a communication link 110 (e.g., comm link, network connection, etc). For example, the aggregator component 102 can obtain a set of data relating to the user 104 by querying one or more internet search engines based on the identifiers.

In addition, the aggregator component 102 can examine, inspect, or otherwise analyze information included in the set of search results, and generate the profile 106 for the user 104 based at least in part on the information. Generation of the profile 106 can include determining a subset of results in the search results, or a set of data included in the search results, that are relevant for inclusion in the profile 106 based on a correlation with a set of predetermined characteristics, or satisfaction of a set of predetermined criterion. For example, the set of predetermined criterion can include, but are not limited to, a relation of a search result to the user 104, a trustworthiness of the source from which the search result was obtained, or a classification of the result. As a more specific example, if the aggregator component 102 returns a social networking website profile for a user having the same name as the user 104, but the profile information (e.g., data birth, email address, etc.) is different from the identifiers known for the user 104, then the aggregator component 102 can determine that the social networking website profile, or information included in the social networking website profile, should not be included in the profile 106. Additionally or alternatively, the profile 106 can be generated by methods, systems, or devices, such as those disclosed in commonly owned, co-pending, U.S. patent application Ser. No. 13/299,877 (“the '877 application”), titled “CONSUMER INFORMATION AGGREGATOR AND PROFILE GENERATOR” herein incorporated by reference.

The scoring calculation component 103 can examine, inspect or otherwise analyze the profile 106, and generate a credit score (e.g., grade, rank, etc.) for the user 104. The scoring calculation component 103 analyzes the profile 106 to determine whether various loan eligibility determination factors (factors) are included in the profile 106. For example, the factors can include, but are not limited to, the user's 104 employment, education, demographics, hobbies, residency, internet usage, and so forth. The credit score can be generated as a function of the factors included in the profile 106. For example, the scoring calculation component 103 can assess, grade, or otherwise weight one or more of the characteristics based on a set of scoring criterion, and determine the credit score as a function of the respective weights of the factors. Additionally or alternatively, the credit score can be determined by methods, systems, or devices, such as those disclosed in commonly owned, co-pending, U.S. patent application Ser. No. 13/305,346 (“the '346 application”), titled “CREDIT SCORING BASED ON INFORMATION AGGREGATION” herein incorporated by reference.

The credit standards component 105 can determine a risk of lending to the user 104 (e.g., potential borrower), and as a function of the risk classify the user 104. The risk can be determined based at least in part on the credit score determined by the scoring calculation component 103. For example, a first classification of potential borrowers can include potential borrowers having a credit score within a first threshold, and a second set of classification can include potential borrowers having a credit score within a second threshold. The classifications can include, for example, acceptable risk and unacceptable risk, or low risk, average risk, and high risk. It is to be appreciated that a virtually infinite number of classifications can be employed. In addition, the credit standards component 105 can generate a set of lending criterion for the user 104 based on the classification, and can determine if the user 104 is eligible for one or more loans by comparing the profile 106 to the set of lending criterion. Where the user is eligible for one or more loans, the credit standards component 105 can determine a set of terms for lending to the user 104 based in part on the user's 104 classification. Returning to the previous example, terms for the set of potential borrowers classified as high risk can include an interest rate that is higher than an interest rate for the set of potential borrowers classified as low risk.

It is to be appreciated that although the profile 106 is illustrated as being stored in a data store 112, such implementation is not so limited. For instance, the profile 106 can be associated with an online shopping portal, stored in a cloud based storage system, or the data store 112 can be included in the aggregator component 102, scoring calculation component 103, credit standards component 105, or one or more data sources 108. In addition, it is to be appreciated that although the aggregator component 102, scoring calculation component 103, and credit standards component 105 are illustrated as stand-alone components, such implementation is not so limited. For instance, the aggregator component 102, scoring calculation component 103, or credit standards component 105 can be associated with or included in a software application, an online shopping portal, and so forth.

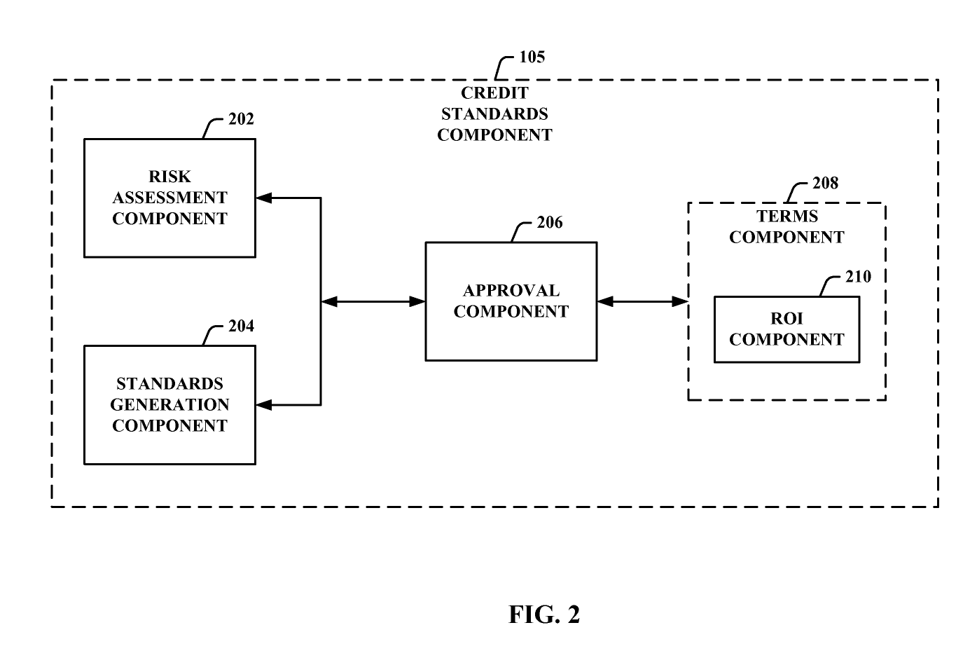

FIG. 2 illustrates an example credit standards component 105 in accordance with various aspects described herein. As discussed, the credit standards component 105 determines a risk of lending to the user 104, and classifies the user 104 as a function of the risk. The credit standards component 105 in FIG. 2 can include a risk assessment component 202, a standards generation component 204, an approval component 206, and terms component 208. The risk assessment component 202 can dynamically classify, rate, or otherwise determine a risk of lending to the user 104 based on a set of risk assessment criterion. The set of risk assessment criterion can include, but is not limited to, risk of loss, expense of lending, or economic conditions. For example, if the user 104 has a high risk of loss, or a high costs of lending, the risk assessment component can classify the user 104 as high risk.

The standards generation component 204 can dynamically set, determine, or otherwise generate a set of lending criterion (e.g., standards) for respective classifications of potential borrowers based at least in part on a set of predetermined criterion or a set of previous lending outcomes. For example, the predetermined criterion can include a desired return on investment (ROI), and the standards generation component 204 can analyze the set of previous lending outcomes for a classification of potential borrowers, and adjust or generate the set of lending criterion for the classification of potential borrowers to achieve the desired return on investment. The set of lending criterion can include satisfaction of a credit score threshold, an income requirement, a residency requirement, an age requirement, an employment requirement, an education requirement, a banking requirement (e.g., checking account, savings account, etc.), a personal information requirement (e.g., marriage, hobbies, vacation, etc.), or satisfaction of virtually any requirement regarding virtually information relating to the user 104.

The approval component 206 can determine whether the user 104 is eligible for one or more loans by comparing the profile 106 associated with the user 104 to the set of lending criterion. For example, the approval component 206 can determine that the user 104 is included in a first classification of potential borrowers by the risk assessment component 202, obtain a first set of lending criterion for potential borrowers having the first classification from the standards generation component 204, and based on the user's 104 profile determine if the user 104 satisfies the first set of lending criterion. If the user 104 satisfies the first set of lending criterion, then credit standards component 105 can determine that the user 104 is eligible for one or more loans. If the user 104 does not satisfy the first set of lending criterion, then the credit standards component 105 can determine that the user 104 is ineligible for one or more loans. In addition, the approval component 206 can determine whether the user 104 is eligible for the one or more loans based at least in part on a set of additional criterion. For example, the set of additional criterion can include a prior loan history of the user 104, a promotional offer, a managerial override (e.g., authorized user input, etc.), and so forth.

The terms component 208 can select, generate, or otherwise determine a set of terms for a loan, where the user 104 is eligible for a loan. The terms component 208 can select the set of terms from a set of predetermined terms, or the terms component 208 can dynamically generate the set of terms. The terms can include, but are not limited to, a financing amount (e.g., credit limit), an interest rate, a set of service fees, a set of penalties (e.g., late payment, pre-payment, over-the-limit, etc.), a period of the loan, and so forth. In addition, the terms component 208 can include a return on investment (ROI) component 210 that determines a desired ROI for the one or more loans, and the terms component 208 can select or generate the terms for the one or more loans as a function of the desired ROI. For example, the desired ROI can be higher for a high risk loan, than for a low risk loan, and the terms component 208 can generate a set of terms for high risk loans having a higher interest rate than for low risk loans, in order to achieve the desired ROI.

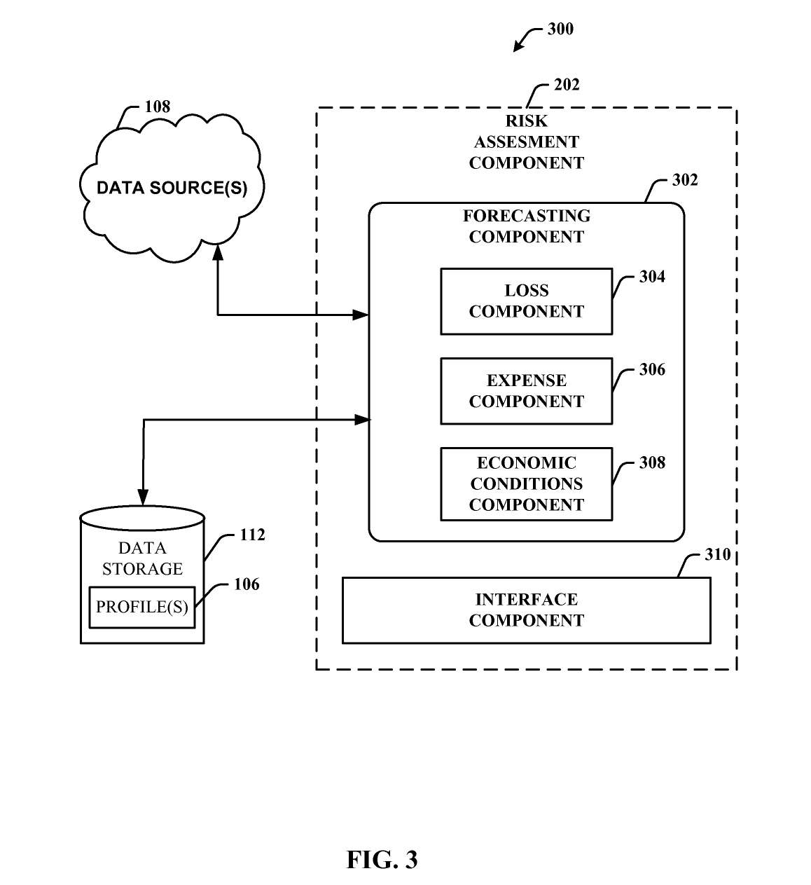

Turning now to FIG. 3, illustrated is an example risk assessment component 202 in accordance with various features described herein. As discussed, the risk assessment component 202 can dynamically determine a risk of lending to the user 104 based in part on a set of risk assessment criterion. The risk assessment component 202 can include a forecasting component 302 that can predict, determine or otherwise forecast a subset of the risk assessment criterion. For example, the forecasting component 302 can include a loss component 304, an expense component 306, and an economic conditions component 308. The loss component 304 can forecast a risk of loss associated with lending to the user 104. The risk of loss can include the risk of loss from the user 104 defaulting on a loan, or the risk of loss associated with the user 104 paying off a loan before the entire term of the loan (e.g., pre-paying the loan). The expense component 306 can forecast the cost or expense associated with making a loan to, or servicing a loan for, the user 104, and the economic conditions component 308 can forecast a set of economic conditions, including, but not limited to, local economic conditions (e.g., for the user 104), or overall economic conditions. For example, the economic conditions component 308 can forecast a potential risk of job loss for the user 104 (e.g., reduced income, likelihood of default).

The forecasting component 302 can obtain, acquire, or otherwise receive information or data for use in forecasting the subset of the risk assessment criterion from virtually any source, including, but not limited to, the set of data sources 108 or the set of profiles 106 maintained in the data store 112. For example, the set of data sources 108 can include a set of websites containing data relating to economic conditions, and the forecasting component 302 can obtain the data from the set of websites, wherein the economic conditions component 308 can employ the data in forecasting local or overall economic conditions. It is to be appreciated that although the forecasting component 302 is illustrated as containing the loss component 304, the expense component 306, and the economic conditions component 308), such implementation is not so limited. For instance, the subset of the risk assessment criterion can include a virtually infinite number of criterion, and the forecasting component 302 can include a virtually infinite number of components to facilitate forecasting the subset of the risk assessment criterion.

In addition, the risk assessment component 202 includes an interface component 310 that includes any suitable and/or necessary adapters, connectors, channels, communication paths, etc. to integrate the risk assessment component 202 into virtually any operating and/or database system(s). Moreover, the interface component 310 can provide various adapters, connectors, channels, communication paths, etc., that provide for interaction with the risk assessment component 202. For example, the interface component 310 can provide for an authorized user (e.g., system administrator, etc.) to input data into the risk assessment component 202. It is to be appreciated that although the interface component 310 is illustrated as incorporated into the risk assessment component 202, such implementation is not so limited. For instance, the interface component 310 can be a stand-alone component to receive or transmit data in relation to the credit standards component 105.

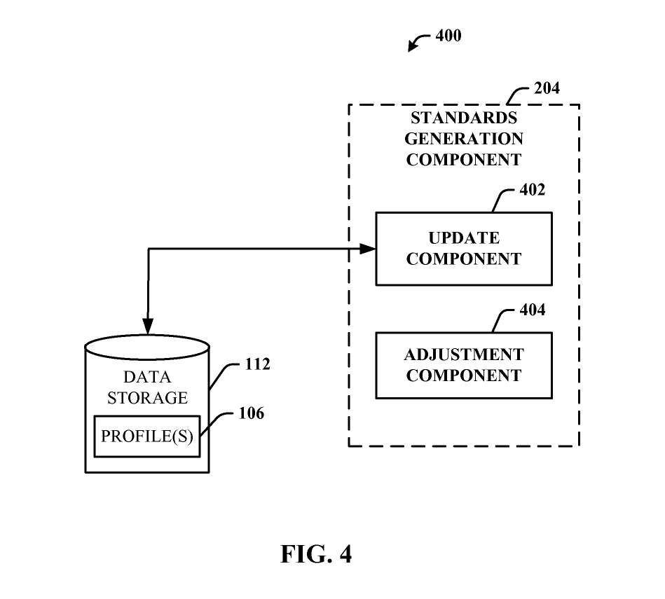

FIG. 4 illustrates an example standards generation component 204 in accordance with various aspects described herein. As discussed, the standards generation component 204 generates a set of lending criterion (e.g., standards) for respective classifications of potential borrowers based at least in part on a set of predetermined criterion or a set of previous lending outcomes. The standards generation component 204 in FIG. 4 can include an update component 402, and an adjustment component 404. The update component 402 can obtain, acquire, or otherwise receive update data for previously granted loans (e.g., previous lending outcomes). For example, the update component 402 can receive data relating to a borrower's default, prepayment, or timely payment of a loan from a profile (e.g., profile 106) associated with the borrower.

The adjustment component 404 modifies, alters, or otherwise adjusts the set of lending criterion for respective classifications of potential borrowers as a function of previous lending outcomes associated with the respective classifications. For example, the adjustment component 404 can adjust the set of lending criterion to increase the difficulty of obtaining a loan (e.g., increase a lending threshold) for a classification of potential borrowers for which there has been a large quantity of defaults. As an additional example, the adjustment component 404 can adjust the set of lending criterion to reduce the difficulty of obtaining a loan (e.g., reduce the lending threshold) for a classification of potential borrowers previously classified as high risk, wherein the classification of potential borrowers has had a large quantity of loans that satisfy a desired return on investment. It is to be appreciated that the update component 402 can receive virtually any update data for previously granted loans, and the adjustment component 404 can adjust a set of lending criterion for a classification of potential borrowers based on virtually any of the update data.

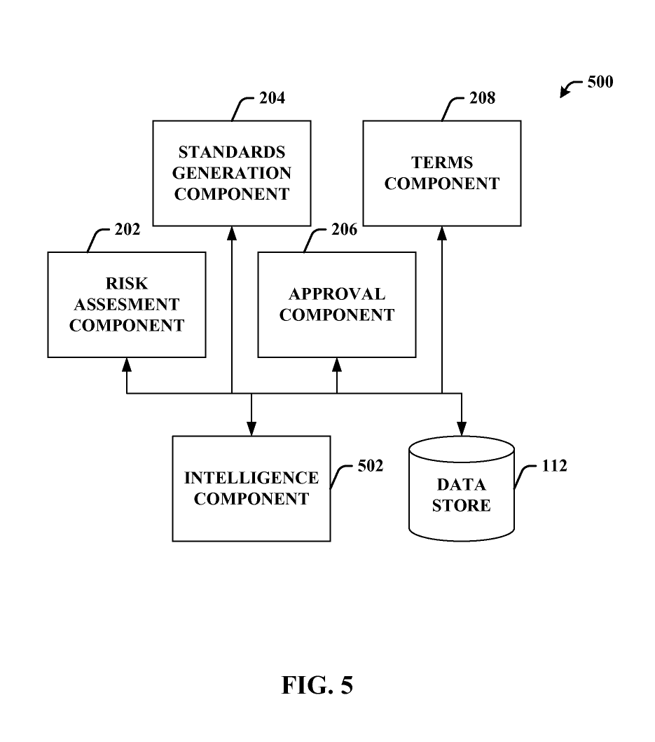

Referring now to FIG. 5, system 500 that can provide for or aid with various inferences or intelligent determinations is depicted. Generally, system 500 can include all or a portion of the risk assessment component 202, the standards generation component 204, the approval component 206, and the terms component 208 as substantially described herein. In addition to what has been described, the above-mentioned components can make intelligent determinations or inferences. For example, standards generation component 204 can intelligently determine or infer a set of lending criterion.

Likewise, the risk assessment component 202 can also employ intelligent determinations or inferences in connection with determining a risk of lending. In addition, the approval component 206 can intelligently determine or infer the user's 104 eligibility for one or more loans. Additionally, the approval component 206 can intelligently determine or infer a set of terms for the one or more loans. Any of the foregoing inferences can potentially be based upon, e.g., Bayesian probabilities or confidence measures or based upon machine learning techniques related to historical analysis, feedback, and/or other determinations or inferences.

In addition, system 500 can also include an intelligence component 502 that can provide for or aid in various inferences or determinations. In particular, in accordance with or in addition to what has been described supra with respect to intelligent determination or inferences provided by various components described herein. For example, all or portions of the risk assessment component 202, the standards generation component 204, the approval component 206, and the terms component 208 (as well as other components described herein) can be operatively coupled to intelligence component 502. Additionally or alternatively, all or portions of intelligence component 502 can be included in one or more components described herein. Moreover, intelligence component 502 will typically have access to all or portions of data sets described herein, such as in the data store 112.

Accordingly, in order to provide for or aid in the numerous inferences described herein, intelligence component 502 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

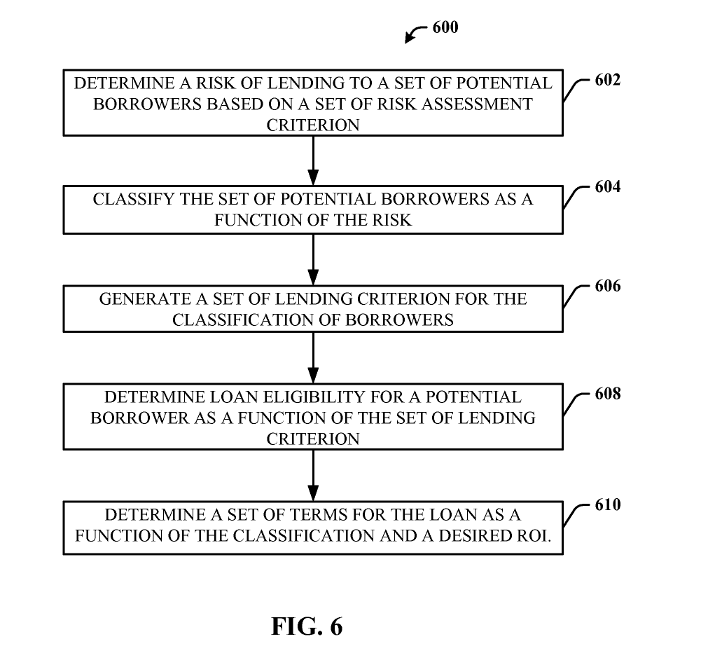

In view of the example systems described supra, methods that may be implemented in accordance with the described subject matter may be better appreciated with reference to the flow chart of FIGS. 6-8. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 6, illustrated is an example methodology for dynamic risk assessment and credit standards generation 600 in accordance with various aspects described herein. Methodology 600 can begin at block 602, wherein a risk of lending can be determined for a potential borrower (e.g., user 104) based on a set of risk assessment criterion. As discussed, the set of risk assessment criterion can include, but is not limited to, risk of loss, expense of lending, or economic conditions. At 604, the potential borrower can be classified as a function of the risk. For example, if the potential borrower has a high risk of loss or a high costs of lending, then the potential borrower can be classified as high risk.

At 606, a set of lending criterion are generated for respective classifications of potential borrowers based at least in part on a set of predetermined criterion or a set of previous lending outcomes. For example, the predetermined criterion can include a desired return on investment (ROI), and the set of lending criterion can be adjusted or generated as a function of the desired ROI and the set of previous lending outcomes for a classification of potential borrowers. The set of lending criterion can include satisfaction of a credit score threshold, an income requirement, a residency requirement, an age requirement, an employment requirement, an education requirement, a banking requirement (e.g., checking account, savings account, etc.), a personal information requirement (e.g., marriage, hobbies, vacation, etc.), or satisfaction of virtually any requirement regarding virtually information relating to the potential borrower.

At 608, a loan eligibility determination is made for the potential borrower as function of the set of lending criterion for the classification associated with the potential borrower. For example, the potential borrower can be included in a first classification, wherein a first set of lending criterion have been determined for the first classification. If the potential borrower satisfies the first set of lending criterion, then the potential borrower can be determined eligible for one or more loans.

Where the potential borrower is eligible for one or more loans, at 610, a set of terms are generated for the one or more loans as a function of the classification and a desired return on investment (ROI). The loan terms can include, but are not limited to, a financing amount (e.g., credit limit), an interest rate, a set of service fees, a set of penalties (e.g., late payment, pre-payment, over-the-limit, etc.), a period of the loan, and so forth. For example, high risk loans can have a relatively high desired ROI, and in order to achieve the desired ROI, the set of terms generated for high risk loans can include a higher interest rate than the interest rate for low risk loans.

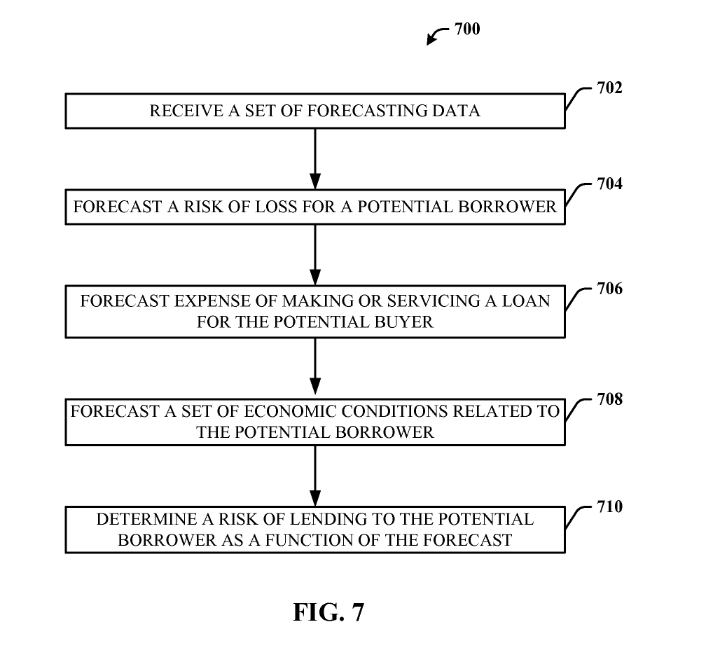

FIG. 7 illustrates an example methodology for dynamic risk assessment in accordance with various aspects described herein. Methodology 700 can begin at block 702, wherein a set of forecasting data is received. The forecasting data can be received from virtually any source, including, but not limited to, a set of data sources, or a set of profiles associated with previous borrowers and/or potential borrowers. For example, the set of data sources can include a set of websites containing data relating to economic conditions. At 704, a risk of loss can be forecast for a potential borrower as a function of a first subset of the forecasting data and/or a profile associated with the potential borrower. The risk of loss can include the risk of loss from the potential borrower defaulting on a loan, or the risk of loss associated with the potential borrower paying off a loan before the entire term of the loan (e.g., pre-paying the loan).

At 706, a cost or expense of associated with making a loan to, or servicing a loan for, the potential borrower (e.g., expense of lending to the potential borrower) can be forecast as a function of a second subset of the forecasting data and/or the profile associated with the potential borrower. At 708, a set of economic conditions can be forecast as a function of a third subset of the forecasting data and/or the profile associated with the potential borrower. The economic conditions can include an overall economic condition, and or a local economic condition related to the potential borrower. For example, if the potential borrower is employed in a job industry that is facing rapid growth locally, then the economic conditions forecast can account for such local growth. As an additional example, a potential risk of job loss for the potential borrower (e.g., reduced income, likelihood of default) can also be forecast.

At 710, a risk of lending to the potential borrower can be determined as a function of the forecast of the risk of loss, the expense of lending to the potential borrower, or the set of economic conditions. As discussed, the potential borrower can be classified based at least in part on the risk determined, and a loan eligibility determination can be made in part on the classification.

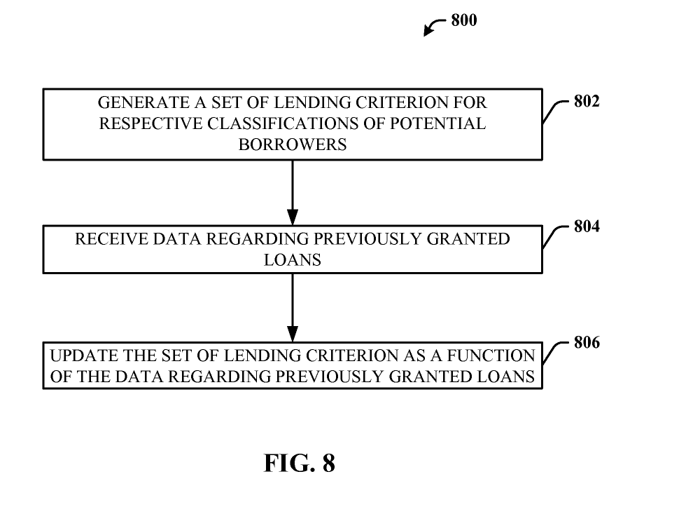

Turning now to FIG. 8, illustrated is an example methodology for dynamic standards generation 800 in accordance with various aspects described herein. Methodology 800 can begin at block 802, wherein a set of lending criterion can be generated for respective classifications of potential borrowers. As discussed, potential borrowers can be classified as a function of determination of a risk of lending to the potential borrowers. For example, if the risk of lending for a potential borrower is determined to be relatively low, then the potential borrower can be classified as “low risk.” The set of lending criterion can include satisfaction of a credit score threshold, an income requirement, a residency requirement, an age requirement, an employment requirement, an education requirement, a banking requirement (e.g., checking account, savings account, etc.), a personal information requirement (e.g., marriage, hobbies, vacation, etc.), or satisfaction of virtually any requirement regarding virtually information relating to a user 104 or set of potential borrowers.

At 804, data regarding previously granted loans (e.g., update data, previous lending outcomes, etc.) can be received. For example, the data can include data relating to one or more borrowers default, prepayment, or timely payment of a previously granted loan. At 808, the set of lending criterion for respective classifications of potential borrowers can be updated as a function of the data regarding previously granted loans. For example, the set of lending criterion can be adjusted to increase the difficulty of obtaining a loan (e.g., raise a lending threshold) for a classification of potential borrowers for which the data regarding previously granted loans includes a large quantity of defaults. As an additional example, the set of lending criterion can be adjusted to reduce the difficulty of obtaining a loan (e.g., lower a lending threshold) for a set of potential borrowers previously classified as high risk, wherein the data regarding previously granted loans indicates that there have been a large quantity of loans that satisfy a desired return on investment. It is to be appreciated that such adjustments enable a lender to dynamically adjust lending requirements in a relatively short period of time in response to actual results obtained by the lender.

### Exemplary Networked and Distributed Environments

One of ordinary skill in the art can appreciate that the various non-limiting embodiments of the shared shopping systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

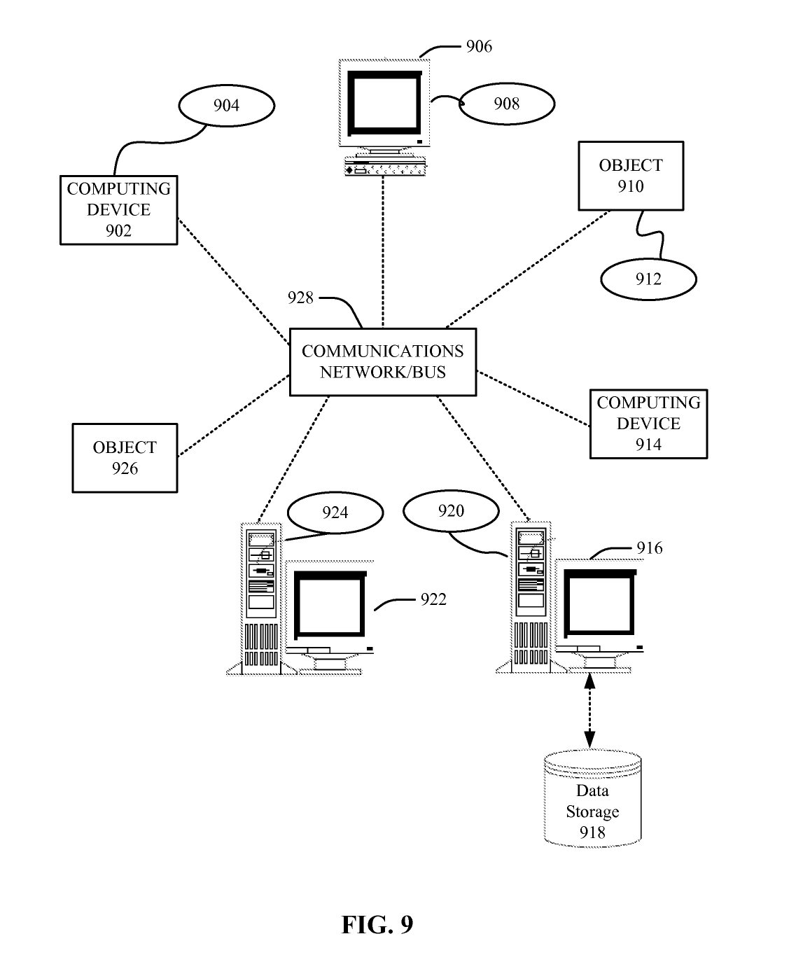

FIG. 9 provides a schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects 910, 912, etc. and computing objects or devices 920, 922, 924, 926, 928, etc. may comprise different devices, such as personal digital assistants (PDAs), audio/video devices, mobile phones, MP3 players, personal computers, laptops, etc.

Each computing object 910, 912, etc. and computing objects or devices 920, 922, 924, 926, 928, etc. can communicate with one or more other computing objects 910, 912, etc. and computing objects or devices 920, 922, 924, 926, 928, etc. by way of the communications network 940, either directly or indirectly. Even though illustrated as a single element in FIG. 9, communications network 940 may comprise other computing objects and computing devices that provide services to the system of FIG. 9, and/or may represent multiple interconnected networks, which are not shown. Each computing object 910, 912, etc. or computing object or device 920, 922, 924, 926, 928, etc. can also contain an application, such as applications 930, 932, 934, 936, 938, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself

In client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects 910, 912, etc. can be thought of as servers where computing objects 910, 912, etc., acting as servers provide data services, such as receiving data from client computing objects or devices 920, 922, 924, 926, 928, etc., storing of data, processing of data, transmitting data to client computing objects or devices 920, 922, 924, 926, 928, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 940 or bus is the Internet, for example, the computing objects 910, 912, etc. can be Web servers with which other computing objects or devices 920, 922, 924, 926, 928, etc. communicate via any of a number of known protocols, such as the hypertext transfer protocol (HTTP). Computing objects 910, 912, etc. acting as servers may also serve as clients, e.g., computing objects or devices 920, 922, 924, 926, 928, etc., as may be characteristic of a distributed computing environment.

### Exemplary Computing Device

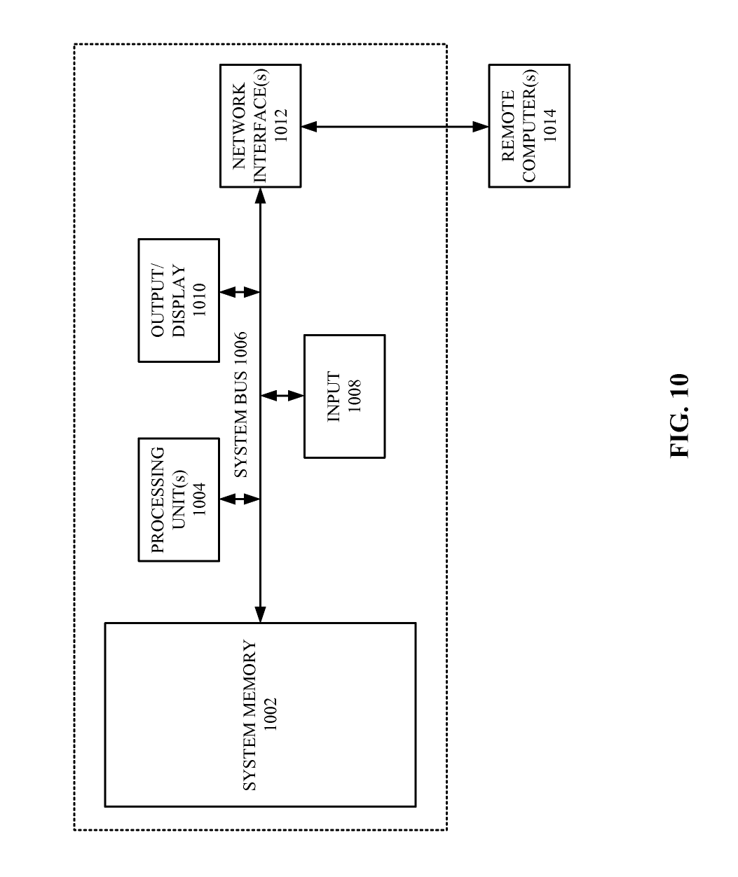

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 10 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 10 thus illustrates an example of a suitable computing system environment 1000 in which one or aspects of the non-limiting embodiments described herein can be implemented, although as made clear above, the computing system environment 1000 is only one example of a suitable computing environment and is not intended to suggest any limitation as to scope of use or functionality. Neither should the computing system environment 1000 be interpreted as having any dependency or requirement relating to any one or combination of components illustrated in the exemplary computing system environment 1000.

With reference to FIG. 10, an exemplary remote device for implementing one or more non-limiting embodiments includes a general purpose computing device in the form of a computer 1010. Components of computer 1010 may include, but are not limited to, a processing unit 1020, a system memory 1030, and a system bus 1022 that couples various system components including the system memory to the processing unit 1020.

Computer 1010 typically includes a variety of computer readable media and can be any available media that can be accessed by computer 1010. The system memory 1030 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 1030 may also include an operating system, application programs, other program modules, and program data.

A user can enter commands and information into the computer 1010 through input devices 1040. A monitor or other type of display device is also connected to the system bus 1022 via an interface, such as output interface 1050. In addition to a monitor, computers can also include other peripheral output devices such as speakers and a printer, which may be connected through output interface 1050.

The computer 1010 may operate in a networked or distributed environment using logical connections to one or more other remote computers, such as remote computer 1070. The remote computer 1070 may be a personal computer, a server, a router, a network PC, a peer device or other common network node, or any other remote media consumption or transmission device, and may include any or all of the elements described above relative to the computer 1010. The logical connections depicted in FIG. 10 include a network 1072, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” or “a set of criterion” can include one criterion, or many criteria.

A number of embodiments have been described. Nevertheless, it will be understood that various modifications may be made without departing from the spirit and scope of the disclosure.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims and their equivalents.

1. A system, comprising:
a memory to store at least one computer-executable component; and
a processor, communicatively coupled to the memory, to execute or facilitate execution of the at least one computer-executable component, the at least one computer-executable component comprising:
a risk assessment component configured to determine a risk of lending to a potential borrower based at least in part on a set of risk assessment criteria, and classify the potential borrower as a function of the risk with a classification, wherein the set of risk assessment criteria includes at least one economic condition of a set of economic conditions;
a standards generation component configured to determine a set of lending criteria for the classification; and
an approval component configured to determine an eligibility of the potential borrower for at least one loan based on a comparison of a profile associated with the potential borrower and the set of lending criteria.

2. The system of claim 1, further comprising a terms component configured to generate a set of terms for the at least one loan.

3. The system of claim 2, further comprising a return on investment component configured to determine a specified return on investment for the at least one loan as a function of the classification.

4. The system of claim 3, wherein the terms component is further configured to generate the set of terms as a function of the specified return on investment.

5. The system of claim 1, wherein the risk assessment component is further configured to determine the at least one economic condition of the set of economic conditions based at least in part on data retrieved from a set of source devices containing data related to the set of economic conditions.

6. The system of claim 1, wherein the set of risk assessment criteria further includes at least one of a risk of loss or an expense of lending to the potential borrower.

7. The system of claim 1, wherein the standards generation component is further configured to receive a set of data regarding previously granted loans, and update the set of lending criteria based on the set of data.

8. A method, comprising:
determining, using at least one processor, a risk of lending to a user identity including predicting a set of risk assessment criteria, and classifying the user identity as a function of the risk with a classification, wherein the predicting the set of risk assessment criteria includes predicting at least one economic condition of a set of economic conditions;
generating a set of lending criteria for the classification; and
determining an eligibility of the user identity for one or more loans based on comparing a profile associated with the user identity and the set of lending criteria.

9. The method of claim 8, further comprising generating a set of terms for the one or more loans as a function of a specified return on investment.

10. The method of claim 8, wherein the determining the risk of lending to the user identity includes predicting the at least one economic condition of the set of economic conditions based at least in part on a set of sources containing data related to the set of economic conditions.

11. The method of claim 8, wherein the predicting the set of risk assessment criteria further includes predicting at least one of a risk of loss associated with the user identity or an expense of lending to the user identity.

12. The method of claim 8, further comprising receiving a set of data regarding previously granted loans, and adjusting the set of lending criteria based on the set of data.

13. A computer readable storage medium comprising computer executable instructions that, in response to execution, cause a computing system including a processor to perform operations, comprising:
determining a risk of lending to a potential borrower identity including forecasting a set of risk assessment criteria, and classifying the potential borrower identity based at least in part on the risk with a classification, wherein the forecasting the set of risk assessment criteria includes forecasting an economic condition of a set of economic conditions;
generating a set of lending criteria for the classification of the potential borrower identity; and
determining an eligibility of the potential borrower identity for at least one loan based on comparing a profile associated with the potential borrower identity and the set of lending criteria.

14. The computer readable storage medium of claim 13, further comprising generating a set of terms for the at least one loan as a function of a defined return on investment.

15. The computer readable storage medium of claim 13, wherein the determining the risk of lending to the potential borrower identity includes forecasting the economic condition based at least in part on data received from network devices storing data related to the set of economic conditions.

16. The computer readable storage medium of claim 13, wherein the forecasting the set of risk assessment criteria further includes forecasting at least one of a risk of loss associated with the potential borrower identity or an expense of lending to the potential borrower identity.

17. The computer readable storage medium of claim 13, further comprising receiving a set of data regarding previously granted loans, and adjusting the set of lending criteria based on the set of data.

18. A system, comprising:
means for determining a risk of lending to a potential borrower based at least in part on a set of risk assessment criteria, and classifying the potential borrower as a function of the risk with a classification, wherein the set of risk assessment criteria includes at least one economic condition of a set of economic conditions;
means for generating a set of lending criteria for the classification; and
means for determining an eligibility of the potential borrower for at least one loan including means for comparing a profile associated with the potential borrower and the set of lending criteria.

19. The system of claim 18, wherein the means for determining the risk of lending to the potential borrower includes means for forecasting the at least one economic condition of the set of economic conditions based at least in part on a set of network data stores that store data related to the set of economic conditions.

20. The system of claim 18, further comprising means for receiving a set of data regarding previously granted loans, and means for adjusting the set of lending criteria based on the set of data.
